(19) United States
(12) Patent Application Publication
(10) Pub. No.: US 2015/0035676 A1
(43) Pub. Date: Feb. 5, 2015

(54) PERSONAL SECURITY DEVICES

(71) Applicant: Ralph Mahmoud Omar, Douglas, Isle of Man (GB)

(72) Inventor: Ralph Mahmoud Omar, Douglas, Isle of Man (GB)

(73) Assignee: OMARCO NETWORK SOLUTIONS LIMITED, Douglas, Isle of Man, British Isles (IM)

(21) Appl. No.: 14/130,793

(22) PCT Filed: Jul. 9, 2012
(86) PCT No.: PCT/GB2012/000578

§ 371 Date: May 6, 2014

(30) Foreign Application Priority Data
Jul. 7, 2011 (GB) 1111644.9

(51) Int. Cl. G08B 21/02; H04L 29/08

(52) U.S. Cl. CPC G08B 21/0297; H04L 67/12
USPC 340/573.1

(57) ABSTRACT

A personal security device for use in signaling an alarm event is described which is arranged to be worn on or about the human body in an accessible manner. The device comprises: user-operable activation means for activating a response to an alarm event, the activation means being activatable by a physical change of state caused by user interaction with the activation means and being arranged to indicate activation to the user in a subtle, non-obvious manner, a transmitter responsive to the activation means for transmitting an alarm event signal indicating the occurrence of an alarm event; and an inactive power source integrated into the device, the inactive power source being coupled to the transmitter. The activation means is arranged to interact with the inactive power source to activate the same and thereby electrically power the transmitter and initiate the sending of the alarm event signal.

### FIELD OF THE INVENTION

The present invention concerns improvements relating to personal security devices and in particular, though not exclusively, to tracking and locating technology devices worn by users which can be activated to signal an alarm event.

### BACKGROUND TO THE INVENTION

Tracking and locating technology exists both external to and internal to the human body in security devices. However, in the case of an alarm event such as an attacker mugging a person, many of these security devices are visible to the attacker who can then prevent their use. Similarly, if they are not readily accessible, they are difficult to activate during the alarm event as the person may not have time to find the device and activate it.

A further problem with existing security devices is that often they are activated accidentally without the user's knowledge thereby causing problems with the tracking services provided to monitor the device.

Where existing security devices also suffer is that they require a power source of sufficient power to enable transmission of an alert message to a monitoring service. The power source is either provided in the form of replaceable batteries or rechargeable batteries. In either form, the power source needs periodic charging or periodic replacement, which requires some diligence on the part of the user, which in many cases means that the security device is not operational when it is needed.

There exists a secondary problem in that if the security device has a feature which resembles a switch, this may trigger a reaction in an attacker including removal of the device or further violence. This also affects the effectiveness of the security device and also can pose an additional danger to the user in an alarm event.

There have been some solutions of providing inner body chips. However, the problem here is they are not easily, if at all, self-activating in an alarm situation. Also as the internal body chip would have some form of external panic alarm activator, this could be smashed or disabled and so this doesn't solve the educated attacker issue.

It is desired to provide a security device which mitigates at least some of the above described problems.

### SUMMARY OF THE INVENTION

The present invention is directed to addressing these problems and concurrent other issues.

According to one aspect of the present invention there is provided: a personal security device for use in signaling an alarm event, the device being arranged to be worn on or about the human body in an accessible manner, the device comprising: user-operable activation means for activating a response to an alarm event, the activation means being activatable by a physical change of state caused by user interaction with the activation means and being arranged to indicate activation to the user in a subtle, non-obvious manner, a transmitter responsive to the activation means for transmitting an alarm event signal indicating the occurrence of an alarm event; and an inactive power source integrated into the device, the inactive power source being coupled to the transmitter; wherein the activation means is arranged to interact with the inactive power source to activate the same and thereby electrically power the transmitter and initiate the sending of the alarm event signal.

The present invention provides a device which is readily and constantly accessible, and whose activation is not readily noticeable or visible to an attacker. The provision of a chemically-activated instant power source obviates the need for rechargeable or replaceable batteries. The security device is easily to hand or worn constantly on the body of the user. In this way at least some of the shortcomings of previous security devices are addressed.

The term “user operable” has been used broadly in this specification, such that it refers to direct actions that the user can take on the device, such as squeezing it, as well as activating the device by causing it to separate from the user or another device, for example by throwing it, or dropping it and moving away.

Furthermore the term “subtle, non-obvious manner”, should be understood to mean that the device is arranged to indicate activation to the user in such a way that an attacker would be unlikely to notice the device or become aware that the user is in possession of an alarm of any kind.

Preferably the inactive power source comprises a plurality of chambers, each chamber retaining a different chemical substance which when brought into contact with other chemical substances creates an electrical potential, and wherein the action of the activation means causes the plurality of chemical substances from different chambers to combine.

The chemicals in the power source chambers are preferably held in separation until the activation means is activated by the user. This has the advantage of giving a very long life to the inactive power source.

The activation means are arranged in one embodiment to bring the chemicals into contact with each other through a planned failure mechanism.

The planned failure mechanism may take the form of a weak coupling pin or a ring-pull mechanism. Also the planned failure mechanism may be made from a material that is weaker than the material of the adjacent components of the device.

The power source chambers may, in another embodiment, be arranged to fail under the action of a crushing force, thereby releasing the different chemicals to mix with each other. Preferably in this embodiment a structure of the plurality of power source chambers is honeycomb-like.

The activation means when activated directly by the user may provide a direct crushing force on the power source chambers.

Alternatively, the activation means when activated by the user may provide an indirect crushing force on the power source chambers via an activatable mechanism acting in response to receipt of an electrical activation signal generated by the activating means.

The activation means may be arranged to be activated when the user applies direct pressure to the device. Preferably the direct pressure is applied through pulling, pushing, hitting, kicking or squeezing the activation means.

Alternatively the activation means may be arranged to be activated when the user removes the device from their body. In this case, the activation means may comprise a biometric sensor arranged to detect the proximity of the device to the user's body. Alternatively, the activation means can comprise an electrostatic charge sensor arranged to be charged by the proximity of the device to the user's body.

The activation means may comprise a pair of exposed electrical terminals which are arranged to complete an electrical circuit and activate the device when an electrical conductor or conducting medium is placed between the terminals.

The device may further comprise fine electrical wires positioned between the power source and the transmitter for providing the power generated by the power source to the transmitter, in use. The fine wires may be dimensioned to not be readily visible to the naked eye to prevent an attacker noticing the presence of the security device.

Alternatively the device may further comprise a flexible printed circuit embedded within a rubber membrane positioned between the power source and the transmitter for providing the power generated by the power source to the transmitter, in use.

The transmitter may comprise a SIM card for sending data to a mobile network.

The transmitter may comprise a GPS chip arranged to transmit current location data of the device. Alternatively, the device can be arranged to connect to a separate GPS locator with a SIM card to send an alarm event notification containing current location data of the GPS locator.

The device can also be arranged in another embodiment to connect to a microchip held by the user with its own SIM card to send an alarm event notification containing current location data of the microchip.

The transmitter is preferably arranged to send an alarm event signal directly to a tracking system.

Alternatively the transmitter may be a short-range transmitter and can be arranged to send an alarm event notification signal to a mobile telecommunications device in the vicinity of the transmitter.

Preferably the activation means is arranged to change the colour of the security device to indicate its activation. Also preferably the device comprises at least some transparent electrical components. Both of these features make the detection of the article as a security device less obvious.

The device may be arranged to be retro-fitted to an existing wearable item, such as a watch. Alternatively the device can be integrated into a watch. In some embodiments the device can be realised as a bracelet or an earpiece. In other embodiments the device can be realised as a tape, medical plaster or skin patch to be applied to the user's body.

Preferably the transmitter is arranged to send an alert signal which causes a mobile base station to log all other mobile phones within a given radius of the security device current location and make them available as potential locators and/or microphones. This is a useful way of catching an attacker in an alert situation.

The present invention also extends to a system comprising a device as described above in combination with a mobile telecommunications device, wherein the mobile telecommunications device is arranged to send the alarm event notification on to a tracking system.

The mobile telecommunications device may be configured to send current location data derived either from the mobile device's GPS chip or the security device's GPS chip, in the alarm event notification.

The mobile telecommunications device may be arranged to provide an opportunity for the user to prevent the sending of the alarm event notification once the activation means has been activated. This is important to prevent unnecessary false alarms. In one embodiment the mobile telecommunications device is arranged to prevent the sending of the alarm event notification on receipt of a predetermined input code into the mobile telecommunications device within a given time period.

The security device may monitor the proximity of the mobile telecommunications device. In this case, the activation means may be arranged to be activated if the activation means does not detect the proximity of the mobile telecommunications device.

The mobile telecommunications device may be configured to be used as a live microphone for the tracking system when an alarm event notification has been sent.

The mobile telecommunications device can be configured to emit an audible distress signal once the alarm event notification has been transmitted. This may act as a deterrent to further attack for the victim.

According to another aspect of the present invention there is provided a method of signaling an alarm event using a personal security device, the method comprising: wearing the device on or about the human body in an accessible manner, activating a response to an alarm event by causing by a physical change of state in activation means of the personal security device, the activation being caused by user interaction with the activation means; indicating activation to the user in a subtle, non-obvious manner; transmitting an alarm event signal indicating the occurrence of an alarm event from a transmitter of the personal security device, in response to the activation; coupling an inactive power source integrated into the device to the transmitter; wherein the user interaction interacts with the inactive power source to activate the same and thereby electrically power the transmitter and initiate the sending of the alarm event signal.

### BRIEF DESCRIPTION OF THE DRAWINGS

In order that the invention may be more readily understood, preferred non-limiting embodiments thereof will now be described with reference to the accompanying drawings, in which:

FIG. 1 shows the three core elements of an embodiment of the present invention;

FIG. 2 shows an example of a structure for a crush zone used in the chemical chamber power source of FIG. 1;

FIG. 3 shows another embodiment of the invention for use with a device shown in FIG. 1, where a mobile phone is used as a relay for the alarm signal;

FIG. 4 shows the structure of a flexible printed circuit used between the transmitter and the chemical chamber power source of FIG. 1 in accordance with another embodiment of the present invention;

FIG. 5 shows another embodiment of the present invention wherein the security device is part of a watch;

FIG. 6 shows the structure of the elements of the embodiment of the invention illustrated in FIG. 5; and

FIG. 7 shows a flow diagram for the sequence of events for the embodiment shown in FIG. 3.

### DETAILED DESCRIPTION OF THE EMBODIMENTS OF THE INVENTION

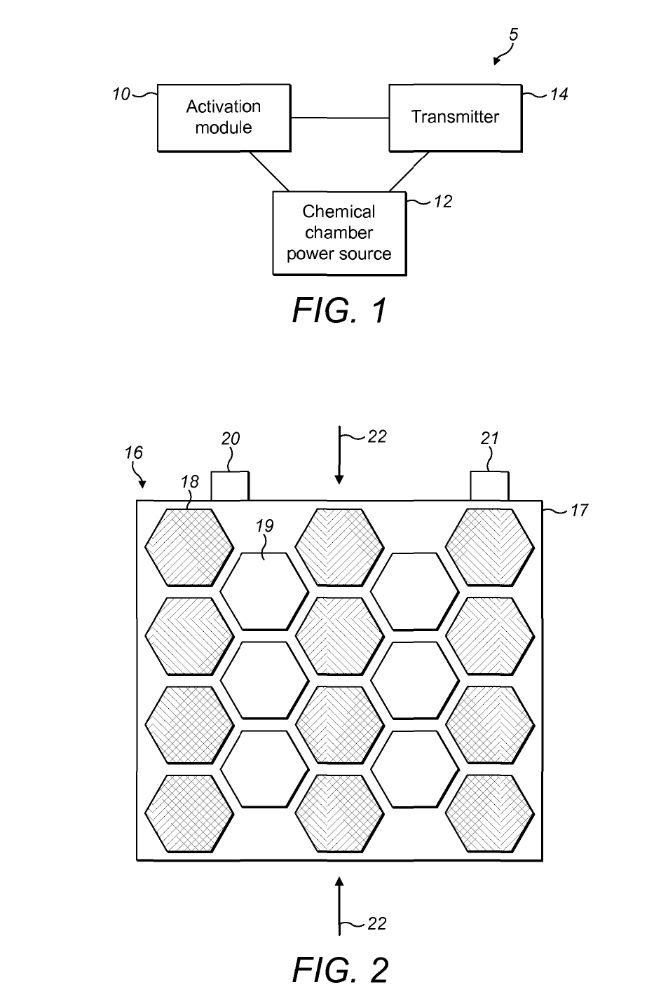

With reference to FIG. 1, there is shown a generic structure of an embodiment of the present invention. The structure of the personal security device 5 comprises three elements all connected to each other; an activation module 10, a chemical chamber power source 12, and a transmitter 14.

The activation module 10 is arranged to initiate an alarm event in the device. The chemical chamber 12 contains two or more different chemicals which, when allowed to come into contact with each other through the action of the activation module 10, react to generate electricity. This electricity can then be used to power the transmitter 14.

In one embodiment the chemicals are contained within a structure which prevents them from coming into contact with each other until the activation module 10 disrupts the structure and breaks the barriers that separate them. When the chemicals are brought into contact with each other they mix to form an electrolyte solution. Two electrodes, an anode and a cathode, are in contact with the solution such that chemical reactions are initiated at each electrode, generating a voltage. This voltage can be used to power the transmitter. For example, the electrolyte solution could be a mixture of zinc sulphate and copper sulphate, initially held separately from each other, and the anode and cathode would be made from zinc and copper respectively. The person skilled in the art will be aware that this arrangement bears a resemblance to the arrangement that would be found in a common battery.

In another embodiment, one or more of the electrodes are positioned away from the electrolyte solution, such that when the activation module is activated, the electrodes are brought into contact with the solution, thus initiating a reaction which will generate a voltage, which can be used to initiate and power the transmitter. The power generated for location of the device 5 is 36-72 hours only

Each of the three elements of the device 5 will now be described in more detail.

The primary task that the activation module 10 is required to perform is to break the separation between the chemicals in the chemical chamber power source 12, in order to initiate a chemical reaction which will produce a transient power source, thereby to power the transmitter 14, and indicate to the transmitter that an alarm condition exists.

There are two main options for the way in which the chemicals may be contained in the chemical chamber 12 that will determine how the activation module 10 can affect the mixing of these chemicals to start a reaction.

The first option is illustrated in FIG. 2, in which the chemicals are held in a crush zone 16 within a chemical chamber 17. In this arrangement the chemicals to be mixed are contained in a honeycomb-like structure or similarly separated areas, with a chemical of one type in a first line of cells 18, and a second type of chemical contained in a second line of cells 19, with additional lines following on in a repeating pattern. It will be appreciated that the chemicals could be distributed differently throughout the cells, and indeed a random distribution would be a viable alternative. Additionally, there may be any number of different types of chemicals contained within the structure, but for simplicity only two are shown in FIG. 2. If a pressure generally indicated by arrow 22 is applied to this structure, the cells will break and therefore release the chemicals that they contain. In this way, the chemicals are brought into contact with each other and mix to form a solution. The anode 20 and cathode 21 are in contact with the chamber, such that when the structure breaks they will be brought into contact with the chemical solution so that a chemical reaction is initiated. The pressure 22 could be a result of direct action from the user, whereby the user squeezes the crush zone with their fingers for example, or the device could be arranged to include an additional mechanism that will exert pressure 22 upon receiving an electrical signal. The power required for this would be far smaller than that which is required for operating the transmitter; hence this can be a practical option in some embodiments.

The second option for containing the chemicals in a way that will allow for an activation module 10 to bring them into contact with each other when required is through the use of a planned failure mechanism. In this case, the barrier that separates the chemicals is designed to fail when the device is pulled. It could be a weak coupling pin or chain link, or alternatively a ring pull action could be implemented. This weakness could be achieved through the use of a material that is easily bendable or crushable or movable by human action, and is weak relative to the rest of the device, for example plastic or rubber. As with a crush zone, the activation means in this scenario could either be a result of direct action from the user, or it could be effected by a small electrical signal.

For both of the above-described arrangements, there is a wide range of potential ways in which the device 5 can be arranged to enable to the user to effect the activation in a direct, physical way, and release the chemicals to activate the alarm in a discrete and subtle manner. For example, the invention could be realised as a bracelet that the user can activate simply by ripping it off, or alternatively it could be a push button actuator placed on a shoe, which can be activated by the user simply kicking the shoe against an object to assert the actuator.

The non-limiting embodiments for an electrical activation module 10 include a biometric sensor (not shown) which is in direct contact with the user and senses biometric signals of the wearer, which are arguably as individual as fingerprints, and is an alternative to an invasive inner body chip Similarly an electrostatic charge sensor (not shown) which is connected to the user can be used. The biometric sensor senses the proximity of the device 5 to the human body. So long as the security device senses that the human body is in close proximity to the device 5 no alarm event signal is generated by the transmitter as no alarm condition is considered to exist. The sensor may give a regular signal to indicate that no alarm condition exists. However, once the sensor senses that the device 5 and the human body are no longer in proximity, an alarm condition exists and an alarm event signal is generated. The biometric sensor is also a user-operable activation module 10 in that the removal of the device 5 from close proximity to the human body represents the physical change of state of the device 5 caused by user interaction with the activation module 10. The electrostatic charge sensor will start to lose its charge if removed from the user. Once the charge drops below a predetermined threshold the sensor will send an activation signal to the transmitter. In a similar way to the biometric sensor, the electrostatic charge sensor could also act as the user-operable activation module 10 through the removal of the device 5.

In an alternative embodiment two exposed electrical terminals are provided and arranged such that an electrical circuit is completed if a conductor is placed across them. The conductor can be water for example, such that the device can be activated if the device is placed underwater or in water.

The final element, the transmitter 14, is used to send an alarm signal. However, there several embodiments for how the alarm signal can be used. In one embodiment of the invention, the transmitter sends a simple alarm signal to a tracking network, highlighting that the user is experiencing some form of difficulty. In another embodiment the device can incorporate an integral GPS chip, so that it is also able to transmit the user's location. In a further embodiment the device can incorporate a SIM card, thus enabling the device to connect to a mobile network in order to notify an alarm event.

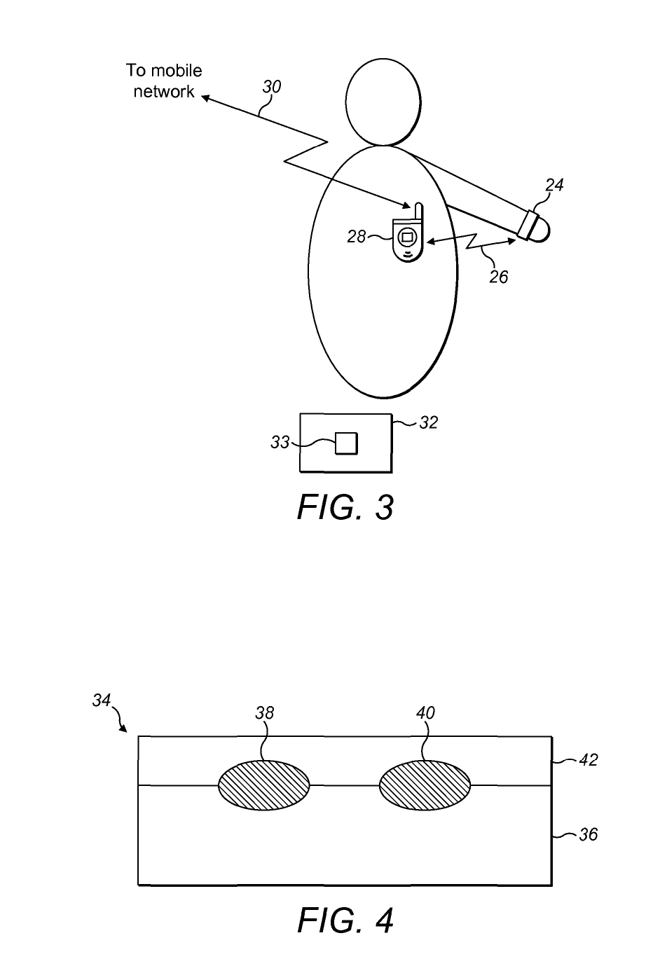

As illustrated in FIG. 3, another embodiment is shown. Here the device 24, realised as a bracelet or watch, sends the alarm signal 26 to the user's mobile phone 28, which can then act as a relay and send an alarm 30 on to the tracking network. The transmission between the device and the phone can be via Bluetooth. This arrangement offers the benefit that the transmitter does not require as much power as it is only sending a single, short range signal, and then making use of the phone's much greater power. Therefore the chemical chamber power source 12 could be smaller, which creates more flexibility in terms of how the device is realised, as the size of the device can be reduced. In this arrangement, the device can also make use of the phone's SIM card and GPS chip, removing any requirement for it to have its own, therefore further enabling a reduction in the size of the device. With this embodiment the alarm signal can alternatively be sent to a monitoring service on a mobile network. In other embodiments of the present invention, the mobile phone can be used to cover several other functions. The first is to start emitting a concealed distress signal, to become a live microphone and to provide geographic locator information. The second is to use Bluetooth to check proximity of the security device to the phone, which could act as an additional activation means. In this case, the phone would start sending an alert with location information as soon as it no longer detects the proximity of the device. The phone could be arranged to require a code for. A third function would be for the mobile phone to emit an audible distress signal upon receiving an alarm signal from the device which has to be stopped by the input of a code, with the normal protection that if that code is put in backwards it immediately alerts that the victim is under duress.

In a further embodiment the transmitter 14 of the security device 5 connects to another transmission device 32 (whether worn internally or externally) such as a GPS locator that contains a SIM card 33 to notify an alarm event. In addition, the SIM card 33 may be placed on or made of a transparent but nonetheless electrically conductive material so as to be provided in a concealed fashion on the transmission device 32 that is otherwise transparent. This accords the security device the same benefits as in the above described embodiment in which a mobile phone is used to send the alarm notification, in that the security device 5 need not have an integral SIM card and GPS chip, along with lower power requirements, and can therefore be smaller. In another embodiment, as an alternative to a GPS locator 32, a microchip which is held by the user could also be used, or in a further non-limiting embodiment the user could be wearing more than one security device, one of which could act as an activator, and the other as a locator.

In a further embodiment of the system, the transmitter 14 is arranged to transmit a signal to cause the mobile base station to log all other mobile phones within a given radius of the security device 5 and make them available as potential locators and/or microphones as these will implicitly belong to the perpetrators of any attack on the victim. For high-value potential victims, the signal may alert overhead satellites to begin tracking the area to identify victims and perpetrators.

An additional feature in the device of the present embodiment comprising the activation module 10, chemical chamber power source 12, and transmitter 14, is that the power generated by the chemical power source 12 together with an activation signal must first be sent to the transmitter. One way in which this can be done is by connecting the two with fine wires, which could be fine enough so as not to be easily visible. The wires could also be concealed within the device.

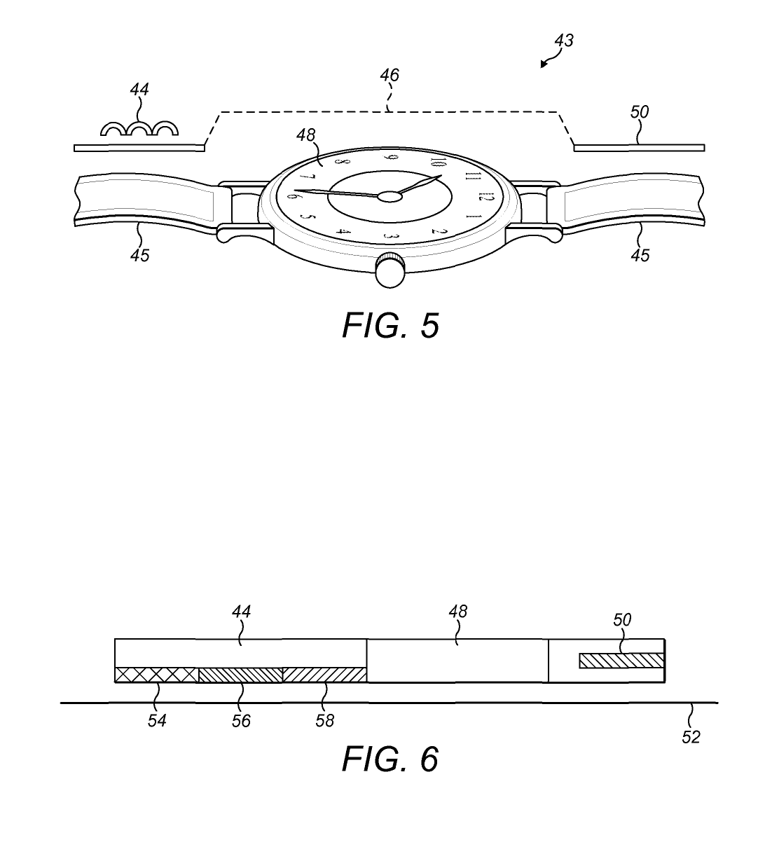

In another embodiment transferring power and the activation signal from the source to the transmitter is through the provision of flexible printed circuits 34 embedded within a rubber membrane 36, as illustrated in FIG. 4. In this case, the circuit is printed in a durable, flexible, non-conductive material 36 creating a plurality of troughs. The troughs are filled with a transparent, flexible and highly conductive ion gel 38, 40 from an ionic liquid compatible, cyclic carbonate network, and then sealed by another non-conductive flexible seal 42; potentially the durable, flexible, non-conductive material. It is also possible to print circuit tracks in a flexible non-conductor which is then filled with conductive gel and sealed with a non-conductive substance linking the thus created conductive circuit to transparent transistors for data processing or memory storage.

It is to be appreciated that such transparent transistors are thin-film transistors (TFTs) and are known—typically being used in display technology. The inclusion of them in the present embodiment provides a printed circuit element which can be used as part of a flexible circuit and which is transparent. The transparency can help in the obfuscation of the security device, in the bracelet or watch of FIG. 3 for example, and thereby avoid detection in the alert event. In addition, the ability to create flexible circuits and circuit components in this manner enables a transparent SIM card to be realised in the security device 5.

As described above, there are many different forms that the activation module can take. Also, the chemical chamber power source can take a number of forms, and furthermore the alarm signal can be transmitted in several ways. It should be appreciated that, while each of these options can be combined with any of the other options, not all of the resulting possible combinations have been described explicitly in this specification. Some further embodiments are now described. These additional embodiments include several practical implementation features.

A particular embodiment of the invention is shown in FIGS. 5 and 6, in which the security device is integrated into a watch 43 which is in contact with the user's skin 52. This includes an activation portion 44 which is provided at one of two watch straps 45 and contains a weakened area or a bubble area 44 rather like bubble wrap (which acts as an activation module 10), but stronger; in use the victim can crush this to create the activation signal. It can also be that the victim pulls off the watch, or part of the watch which has been weakened to fail in a planned way, from the watch strap 45 to create a signal. The activation signal can be sent to the transmitter 50 via fine wires 46 embedded in a rubberised plastic covering 46 bridging across the face 48 of the wrist watch 43. The alarm signal is then generated and transmitted by the transmitter 50. FIG. 6 shows a development of this device, in which two chemicals 54, 56 are held separately in the crush zone 44, and a biometric sensor 58 has also been incorporated as part of the activation module. The biometric sensor operates in use to send a signal that will break the crush zone structure 44 to enable the chemicals 54, 56 to mix if it detects that it is no longer in contact with the user's skin 52.

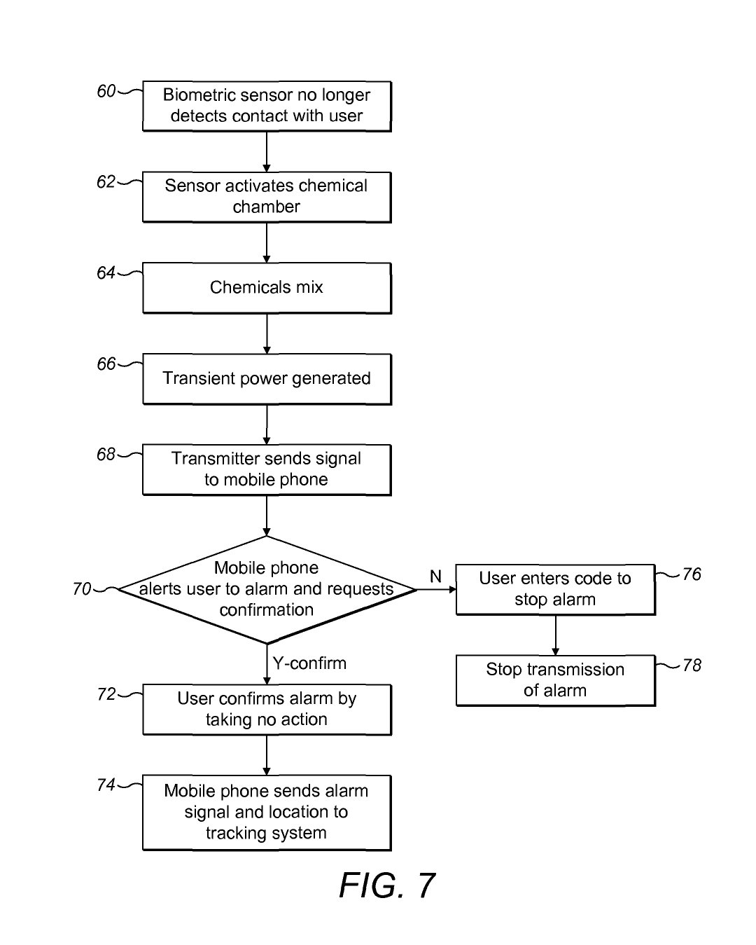

Another embodiment is illustrated by FIG. 7, which shows a method of activation of a personal security device. The figure shows the sequence of events involved in the generation of an alarm event/signal. This is an example sequence only; the sequence of events in different embodiments will not be the same, it will depend on which components have been used in the device in each particular embodiment. The device implementing this method is similar to that described in the previous embodiment with reference to FIG. 6, in that it incorporates a biometric sensor 60 which senses when the device is no longer in contact with the user. The sensor then activates at Step 62 the chemical chamber, causing the chemicals to mix at Step 64 and react with each other to generate at Step 66 electricity. This event sends an activation signal to the transmitter and powers the transmission at Step 68 of an alarm signal to the user's mobile phone. In this embodiment, the mobile phone is arranged to warn at Step 70 the victim that it has been accidentally fired and can seek at Step 70 confirmation before transmitting the alarm signal to a monitoring site. The user will need to do nothing at Step 72 in order to confirm the alarm, whereupon the mobile phone sends at Step 74 the alarm signal with location data on to a tracking system. Alternatively if the alarm is not confirmed by entering a deactivation code at Step 76, then the transmission of the alarm is stopped at Step 78. Confirmation can be carried out in many different ways, but is typically carried out utilising a countdown timer. If during the countdown there is deactivation by entry of the deactivation code, the alarm is stopped at Step 78. Otherwise, if the user takes no action at Step 72, the alarm is sent at Step 74.

In a further non-limiting embodiment of the present invention, the device is realised as a security bracelet. If the device is a bracelet worn as a single device or alternatively another similar constructed device attachable to or integral to a watch strap for example (which is a wraparound of part of all the whole of the watch strap or chain of the potential victim), then it will allow for a subtle change of colour if accidentally fired or it can discretely indicate the activation by going from clear to opaque in certain sections. This principle of alerting the user to an accidental activation by means of a change in colour of the device can be applied to many potential realisations of the invention. This feature could also be used in reverse, in that if the device has an integral SIM card, the tracking company could also “call” the device, which could cause it to change colour. In either case, by the use of a countdown timer as has been described above, it is possible for the confirmation to be in the form of no response by the wearer. This would have the beneficial effect of enabling the alarm to be sent when the user/victim does not wish to alert the attacker to the sending of the signal, but yet has the ability to stop false triggering by deactivation of the transmission of the alarm signal.

Further examples of potential ways in which embodiments of the present invention could be realised shall now be described.

The security device could be embodied in a patch or a cover for an ordinary device e.g. a cover for a button or eyeglasses.

The device may be a bracelet containing the areas of planned failure, or allowing for the separation of the bracelet from the wearer or the tearing of the bracelet, all of these causing an alarm event signal to be fired off.

If the SIM card is constructed out of a transparent material, then conceptually it can be part of a tape or medical plaster, or skin patch that will be applied on a daily basis to the body and would appear innocuous to an attacker.

The locator device 32 can also be mounted as a small ear-worn device to appear as a hearing aid.

A variant for children can be a bracelet or other similar item worn directly upon the infant's or toddler's body that has metal or other electrically conductive materials that would be connected in an electrical circuit by exposure to water, such that contact with water would cause an immediate mobile phone alert to notify a parent that the child has fallen in water.

In addition, the child can carry a small SIM card and GPS locator in a band around the wrist which is inert and with a very small signal receptor standing in for the crush technology, so it can initiate sending of an alarm signal if it moves out of the proximity of a second bracelet worn on a carer's. hand. Also a bracelet that would activate the small low charge signal receptor to break open the inner chemical chamber and power the receptor to activate the locator if ordered by another device e.g. a mobile phone.

The inclusion of planned failure, or crush zone technology in an ordinary everyday device allowing for the ingress or egress of chemicals to cause that device to move from being inert to having an electrical charge, would mean that everyday devices could be manufactured which will include SIM cards and could be concealed in buttons or shoelaces or belt buckles or other devices which are part of clothing and/or jewellery but which nonetheless appear innocuous to allow the victim to activate those devices whilst under threat to allow for the charging of locator devices.

If a permanently invasive device is unattractive to the potential victim, the external signalling device could be linked with a daily pill that would be swallowed which contains a single receptor to activate it, or to cause a further movement to allow for battery charge to occur by the ingress or egress of a chemical from one section of the device to another. The pill would have within it the SIM card and GPS location capabilities.

It will be understood that the embodiments described above are given by way of example only and are not intended to limit the invention. It will also be understood that the embodiments described may be used individually or in combination.

What is claimed is:

1. A personal security device for use in signaling an alarm event, the device being arranged to be worn on or about the human body in an accessible manner, the device comprising:
A user-operable activator for activating a response to an alarm event, the activator being activatable by a physical change of state caused by user interaction with the activator and being arranged to indicate activation to the user in a subtle, non-obvious manner,
a transmitter responsive to the activator for transmitting an alarm event signal indicating the occurrence of an alarm event; and
an inactive power source integrated into the device, the inactive power source being coupled to the transmitter;
Wherein the activator is arranged to interact with the inactive power source to activate the same and thereby electrically power the transmitter and initiate the sending of the alarm event signal.

2. A device according to claim 1, wherein the inactive power source comprises a plurality of chambers, each chamber retaining a different chemical substance which when brought into contact with other chemical substances creates an electrical potential, and wherein the action of the activator causes the plurality of chemical substances from different chambers to combine.

3. A device according to claim 2, wherein the chemicals in the power source chambers are held in separation until the activator is activated by the user.

4. A device according to claim 3, wherein the activator is arranged to bring the chemicals into contact with each other through a planned failure mechanism.

5. A device according to claim 4, wherein the planned failure mechanism takes the form of a weak coupling pin or a ring-pull mechanism.

6. A device according to claim 4, wherein the planned failure mechanism is made from a material that is weaker than the material of the adjacent components of the device.

7. A device according to claim 2, wherein the power source chambers are arranged to fail under the action of a crushing force, thereby releasing the different chemicals to mix with each other.

8. A device according to claim 7, wherein a structure of the plurality of power source chambers are honeycomb-like.

9. A device according to claim 1, wherein the activator when activated directly by the user provides a direct crushing force on the power source chambers.

10. A device according to claim 1, wherein the activator when activated by the user provides indirect crushing force on the power source chambers provided via an activatable mechanism acting in response to receipt of an electrical activation signal generated by the activator.

11. A device according to claim 1, wherein the activator is arranged to activate when the user applies direct pressure to the device.

12. A device according to claim 11, wherein the direct pressure is applied through pulling, pushing, hitting, kicking or squeezing the activator.

13. A device according to claim 10, wherein the activator is arranged to be activated when the user removes the device from their body.

14. A device according to claim 13, wherein the activator comprises a biometric sensor arranged to detect the proximity of the device to the user's body.

15. A device according to claim 13, wherein the activator comprises an electrostatic charge sensor arranged to be charged by the proximity of the device to the user's body.

16. A device according to claim 13, wherein the activator comprises a pair of exposed electrical terminals which are arranged to complete an electrical circuit and activate the device when an electrical conductor or conducting medium is placed between the terminals.

17. A device according to claim 1, further comprising fine electrical wires positioned between the power source and the transmitter for providing the power generated by the power source to the transmitter, in use.

18. A device according to claim 1, further comprising a flexible printed circuit embedded within a rubber membrane positioned between the power source and the transmitter for providing the power generated by the power source to the transmitter, in use.

19. A device according to claim 1, wherein the transmitter comprises a SIM card for sending data to a mobile network.

20. A device according to claim 1, wherein the transmitter comprises a GPS chip arranged to transmit current location data of the device.

21. A device according to claim 1, wherein the device is arranged to connect to a GPS locator with a SIM card to send an alarm event notification containing current location data of the GPS locator.

22. A device according to claim 1, wherein the device is arranged to connect to a microchip held by the user with a SIM card to send an alarm event notification containing current location data of the microchip.

23. A device according to claim 1, wherein the transmitter is arranged to send an alarm event signal directly to a tracking system.

24. A device according to claim 1, wherein the transmitter is a short-range transmitter and is arranged to send an alarm event notification signal to a mobile telecommunications device in the vicinity of the transmitter.

25. A device according to claim 1, wherein the activator is arranged to change the colour of the security device to indicate its activation.

26. A device according to claim 1, wherein the device comprises at least some transparent electrical components.

27. A device according to claim 1, which is arranged to be retro-fitted to an existing wearable item, such as a watch.

28. A device according to claim 1, wherein the device is integrated into a watch.

29. A device according to claim 1, wherein the device is realised as one element from the group comprising a bracelet, a tape, medical plaster or skin patch to be applied to the user's body, and an earpiece.

30. (canceled)

31. (canceled)

32. A device according to claim 1, wherein the transmitter is arranged to send an alert signal which causes a mobile base station to log all other mobile phones within a given radius of the security device current location and make them available as potential locators and/or microphones.

33. A system comprising a device according to claim 24, in combination with a mobile telecommunications device, wherein the mobile telecommunications device is arranged to send the alarm event notification on to a tracking system.

34. A system according to claim 33, wherein the mobile telecommunications device is configured to send current location data derived either from the mobile device's GPS chip or the security device's GPS chip, in the alarm event notification.

35. A system according to claim 33, wherein the mobile telecommunications device is arranged to provide an opportunity for the user to prevent the sending of the alarm event notification once the activator has been activated.

36. A system according to claim 35, wherein the mobile telecommunications device is arranged to prevent the sending of the alarm event notification on receipt of a predetermined input code into the mobile telecommunications device within a given time period.

37. A system according to claim 33, wherein the security device monitors the proximity of the mobile telecommunications device.

38. The system of claim 37, wherein the activator is arranged to be activated if the activator does not detect the proximity of the mobile telecommunications device.

39. A system according to claim 33, wherein the mobile telecommunications device is configured to be used as a live microphone for the tracking system when an alarm event notification has been sent.

40. A system according to claim 33, wherein the mobile telecommunications device can be configured to emit an audible distress signal when the alarm event notification has been transmitted.

41. A method of signaling an alarm event using a personal security device, the method comprising:
wearing the device on or about the human body in an accessible manner,
activating a response to an alarm event by causing by a physical change of state in an activator of the personal security device, the activation being caused by user interaction with the activator;
indicating activation to the user in a subtle, non-obvious manner;
transmitting an alarm event signal indicating the occurrence of an alarm event from a transmitter of the personal security device, in response to the activation;
coupling an inactive power source integrated into the device to the transmitter;
Wherein the user interaction interacts with the inactive power source to activate the same and thereby electrically power the transmitter and initiate the sending of the alarm event signal.
